(19) United States
(12) Patent Application Publication
(10) Pub. No.: US 2010/0299476 A1
(43) Pub. Date: Nov. 25, 2010

(54) MASS MEMORY DEVICE AND STORAGE SYSTEM

(75) Inventors: Jean-Marie Courteille, Savigny Sur Orge (FR); Francois Guillot, Fresnes (FR)

Correspondence Address: BAKER & DANIELS LLP, 300 NORTH MERIDIAN STREET, SUITE 2700, INDIANAPOLIS, IN, 46204, US

(73) Assignee: SAGEM DEFENSE SECURITE, Paris (FR)

(21) Appl. No.: 12/864,484

(22) PCT Filed: Feb. 2, 2009
(86) PCT No.: PCT/EP2009/051156

§ 371 Date: Jul. 23, 2010

(30) Foreign Application Priority Data
Feb. 5, 2008 (FR) 0800593

(51) Int. Cl. G06F 12/00; G06F 12/02; G06F 15/167

(52) U.S. Cl. 711/103; 709/213; 711/E12.001; 711/E12.008

(57) ABSTRACT

A mass memory device is disclosed as including a memory module, a management module for physical management of the memory module, and a control module for controlling the management module. The management module is connected for communication with the control module by an MII-family bus.

### CROSS-REFERENCE TO RELATED APPLICATION

This application is a National Stage filing of International Application Serial No. PCT/EP2009/051156, filed Feb. 2, 2009, designating the United States, and which claims priority to French patent application Ser. No. 08/00593, filed Feb. 5, 2008 by the same inventor hereto, the disclosures of which are expressly incorporated herein by reference.

### FIELD OF THE DISCLOSURE

The present disclosure concerns computer mass memory devices and more particularly the architecture thereof.

### BACKGROUND AND SUMMARY

The internal architecture of a mass memory device, such as a disk on a SSD (Solid State Drive) memory component, is illustrated in FIG. 1. This architecture is derived from the architecture of hard disks, the main features of which it reproduces. The disk on memory component 1.1 is composed of a physical mass memory module 1.2, in this case a bank of memory components containing the memory components proper. The memory components are generally of the Flash memory type. A physical management module 1.3 for the mass memory manages the reading and writing of data on the physical memory module 1.2. This physical management module 1.3, consisting for example of a programmable component, is connected to a control module 1.4 that manages the high-level commands managing the memory device. These commands comprise commands for direct access to the DMA (Direct Memory Access) memory, management of the read and write burst modes and others. Control module 1.4 comprises a processor and memory for executing firmware managing the memory device. The exchanges between control module 1.4 and physical management module 1.3 of the bank of memory components take place by means of a proprietary communication bus 1.7. Control module 1.4 is connected by this same bus 1.7 to a link adaptation module 1.5 for managing the communication interface 1.6 of the mass memory device with the outside. This interface is today generally in conformity with the S-ATA (Serial Advanced Technology Attachment) standard, the current development of the IDE (Integrated Drive Electronics) standard. These standards, by defining the interface between a computer and a mass memory device, afford interoperability between the various manufacturers of these mass memory devices. The device described here is a device with a memory component base, but any other physical mass memory module can be used, such as a magnetic hard disk or the like.

It is sometimes advantageous to be able to offset these mass memory devices at a distance from the apparatus managing them. This offsetting is not possible using the IDE link limited to a distance of 50 cm. Some mass memory devices include a bus management module, such as for example the USB (Universal Serial Bus). These mass memory devices allow external connection to an information system; however, the maximum offsetting distance remains limited to a distance of around five metres.

To solve this problem of offsetting, designing mass memory devices accessible by network or NAS (Network Attached Storage) is known. These NASs are designed by adding to the disk, as described in FIG. 1, a host system comprising a central unit, an S-ATA interface on one side and a network interface. The central unit manages the disk in the same way as a conventional information system of the computer type and exposes to the network a system of files that can be shared according to conventional file system sharing protocols. These systems therefore involve the implementation of a complex host for managing the mass memory device. This host must include a complex operating system to manage a complete set of network communication protocols. They offer on the other hand the advantage of arbitrary remote access provided that the accessing system and the mass memory device are connected by a communication network.

The present disclosure sets out to propose a mass memory device that can easily be offset while remaining of simple design. This device has a bus from the family of MII (Media Independent Interface) buses connected to the programmable component managing the reading and writing on the memory. This architecture makes it possible to implement the control module of the device at a distance, the communication between the controller and the programmable component being able to be offset on an Ethernet link directly connected to the MII-family bus. This architecture may be adapted for the design of mass memory devices comprising the control module, also devices where the control module is offset and again mass memory devices of the NAS type with simplified architecture. The simple architecture of these devices offer improved security, the certification of which is easier.

The present disclosure concerns a mass memory device comprising a physical mass memory module, a physical management module for the memory controlled by a control module and where the physical management module for the memory has a connection to an MII-family bus for communicating with the control module.

In one embodiment, the device also comprises the control module integrated in the device and directly connected to the physical management module of the memory via the MII-family bus.

In one embodiment, the device also comprises a link adaptation module for managing an interface for communication with a host system under the control of the control module.

In one embodiment, the device also comprises a socket of the Ethernet type and an Ethernet physical management module for managing the socket, the Ethernet physical management module being directly connected to the MII-family bus connected to the physical management module for the memory.

The present disclosure also concerns a storage system comprising a host system comprising a socket of the Ethernet type, an Ethernet physical management module managing the socket, and a control module comprising a processor, and wherein the system comprises at least one mass memory device such as the one above connected by an Ethernet link to the Ethernet socket of the host system and wherein the control module is connected to the Ethernet physical management module of the host system via an MII-family bus, thus enabling it to control the physical management module for the memory of the mass memory device connected through the Ethernet link.

In one embodiment, the module controlling the host on the one hand and the physical management module for the memory on the other hand have means of managing a protocol of commands passing over the Ethernet link, transported in data packets in accordance with the Ethernet standard.

In one embodiment, the host control module on the one hand and the physical management module for the memory on the other hand also have means of managing the command protocol in UDP data packets encapsulated in IP data packets transported in Ethernet packets. This management of the IP protocol makes it possible to pass commands of the protocol over an IP network between the host system and the mass memory device.

In one embodiment, the host system also comprises at least a second Ethernet socket for connecting the host system to a communication network and means of managing a complete network protocol stack by the control module of the host system, making it possible to expose the mass memory device on the communication network, thus forming a mass memory device accessible by network.

### BRIEF DESCRIPTION OF THE DRAWINGS

The features of the present disclosure mentioned above, as well as others, will emerge more clearly from a reading of the following description of example embodiments, the description being given in relation to the accompanying drawings, among which:

FIG. 1 illustrates an example of prior art architecture of mass memory devices.

FIG. 2 illustrates the use of an MII-family bus within an Ethernet interface.

FIG. 3 illustrates the architecture of a mass memory device according to a first embodiment of the disclosure.

FIG. 4 illustrates the architecture of a mass memory device according to a second embodiment of the disclosure.

FIG. 5 illustrates the architecture of a system using the offset control of a mass memory device according to the second embodiment.

FIG. 6 illustrates an example of a protocol that can be used between the control module and the mass memory device.

FIG. 7 illustrates an example of logic architecture of a physical management module for a physical memory module according to the disclosure.

FIG. 8 illustrates the architecture of a mass memory device accessible by a network using a mass memory device according to the second embodiment.

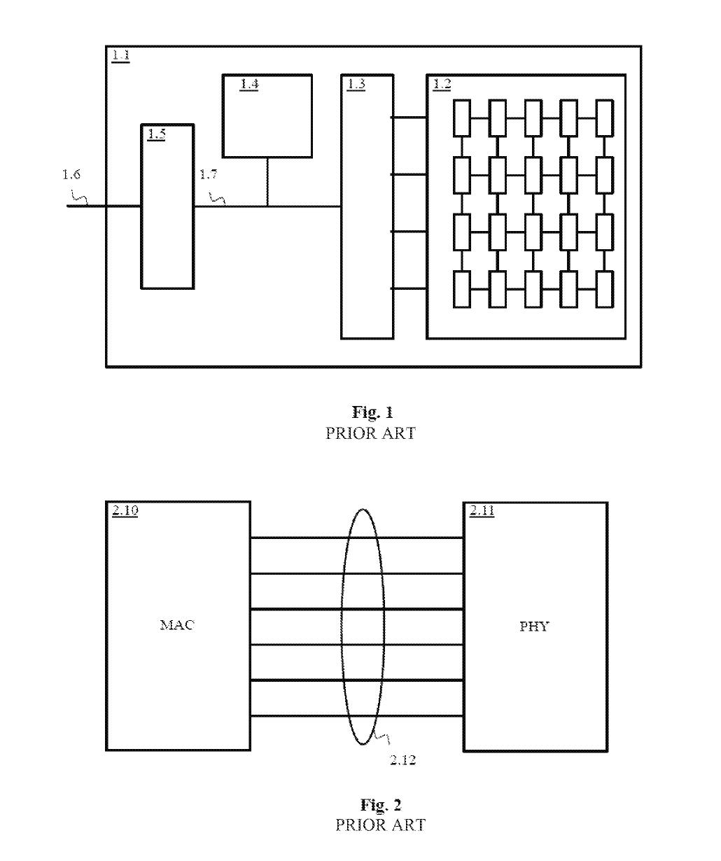

### DETAILED DESCRIPTION OF EMBODIMENTS OF THE DISCLOSURE

The MII (Media Independent Interface) bus is standardised by the IEEE (Institute of Electrical and Electronics Engineers) under the reference IEEE 802.3u. This bus is used for implementing links according to the Ethernet standard defined by the IEEE under the reference 802.3. This bus was developed to manage communication between a physical Ethernet module and an MAC (Media Access Control) Ethernet module. This architecture is illustrated by FIG. 2. In this figure, an MAC Ethernet management module 2.10 is connected to a physical management module 2.11 by an MII bus 2.12. This bus enables 4-bit words to be exchanged in both directions timed by a 25 MHz clock. The physical management module 2.11 manages the sending and reception of the signals transporting the Ethernet data packets over the physical medium. The MAC management module 2.10 takes care of the management of these packets, and composing them. It is controlled by top layers of the stack of network protocols used, typically by the IP layer (Internet Protocol described in RFC 791). This bus has developed to follow the various versions of the Ethernet protocol. The standards RMII (Reduced Media Independent Interface), GMII (Gigabit Media Independent Interface), RGMII (Reduced Gigabit Media Independent Interface), XGMII (10 Gigabit Media Independent Interface) and SGMII (Serial Gigabit Media Independent Interface) can be mentioned. All these buses form a family, here referred to as the MIII bus family, this family needing to be extended further in the future.

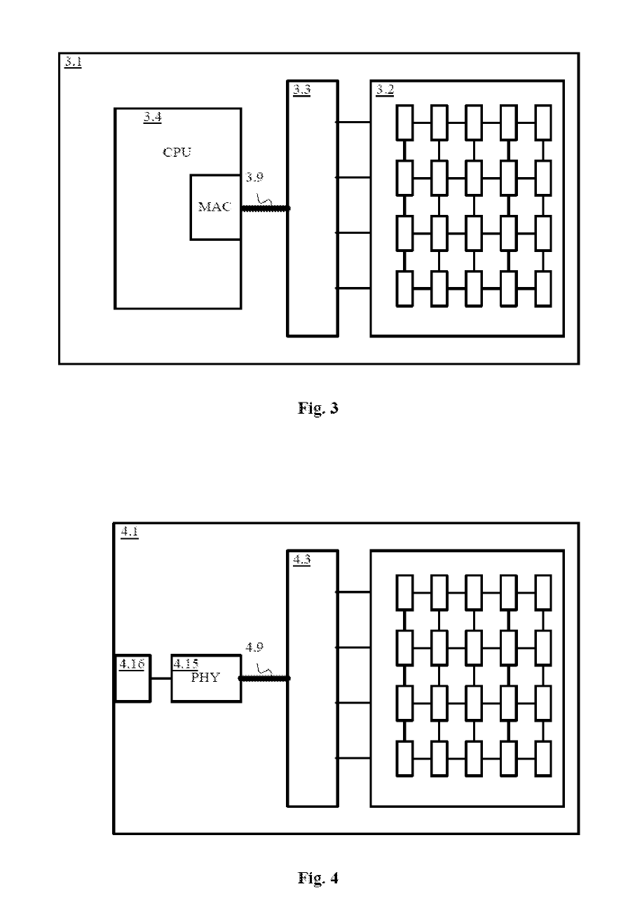

The present disclosure provides for the use of an MII-family bus for communication between the physical management module managing the physical memory module and the control module. FIG. 3 illustrates the architecture of a mass memory device 3.1 using such a bus. The physical memory module 3.2 managed by the physical management module 3.3 can be seen. Mass memory device 3.1 is under the control of control module 3.4. Unlike the prior art, communication between control module 3.4 and physical management module 3.3 is done by means of an MII-family bus 3.9. Control module 3.4 then includes an MAC Ethernet module connected to MII-family bus 3.9. This architecture makes it possible amongst other things to merge on a single processor the control module functionality and the central processor functionality of the host using the disk. The disk can therefore be directly connected to the central processor via MII-family bus 3.9. It is also possible thereby to design a whole family of mass memory devices on the basis of this architecture.

Because of the natural connection of the MII-family buses with an Ethernet physical component, it is possible to introduce an Ethernet link between control module 3.4 and physical management module 3.3. This Ethernet link enables offsetting the physical part of the mass memory device over a distance of around one hundred metres. FIG. 4 illustrates a mass memory device 4.1 that can be used in this way. In this embodiment of the disclosure, the physical management module 4.3 is connected to the MII-family bus 4.9. This bus 4.9 is directly connected to an Ethernet physical module 4.15 directly managing an Ethernet socket 4.16. In one embodiment, the GMII version of the MII-family bus and gigabit Ethernet links are used. In this way high rates are achieved.

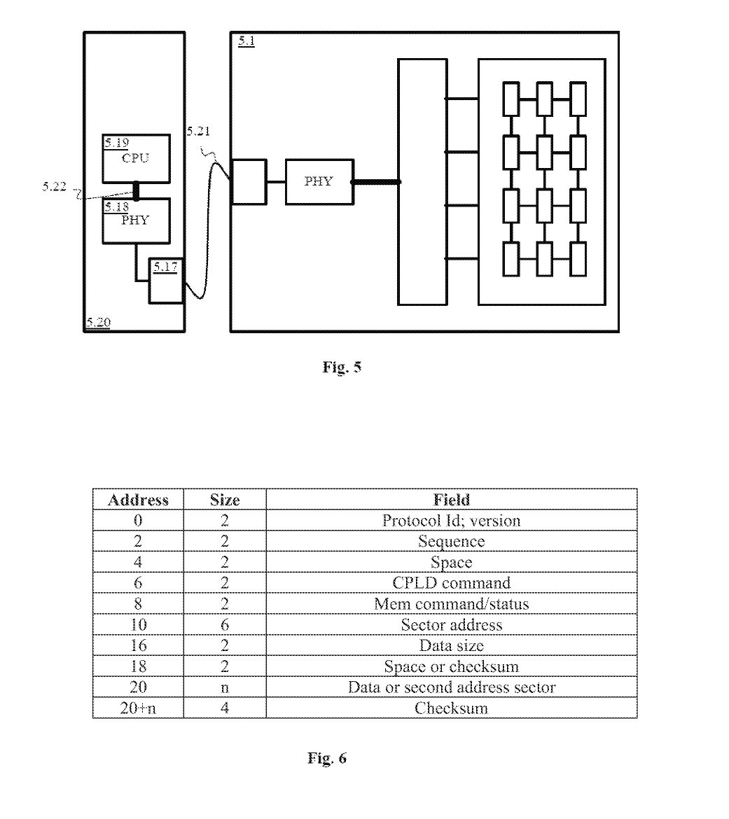

This embodiment enables a storage system like the one illustrated in FIG. 5 to be designed. In this storage system, a mass memory device 5.1, similar to the one in FIG. 4, is connected, via an Ethernet link 5.21 connected to the Ethernet socket, to a distant host system 5.20. Distant host system 5.20 also comprises an Ethernet socket 5.17 managed by an Ethernet physical module 5.18 connected to a control module 5.19 having a processor and an MAC Ethernet module for managing the connection to the MII-family bus 5.22 for communication with the physical Ethernet module 5.18. Since communication over an Ethernet link can extend up to one hundred metres, it is thus possible to offset the physical memory module to this distance from the host containing the controller. The use of Ethernet or optical fibre routing devices makes it possible to increase as required the distance between the host performing the control and the mass memory device. It is also possible to increase the storage capacities as required by connecting to the Ethernet network the necessary number of such mass memory devices 5.1. All these devices can be controlled by the same host comprising the control module.

The possibility of transporting a useful current power over an Ethernet link, for example according to IEEE 802.3 af, makes it possible to design on this model autosupplied simplified devices. These devices may have a small size and offer the same advantages as the memory devices on the USB bus known by the term USB keys. The difference being that the devices according to the present disclosure can be connected at a distance from their control host over an Ethernet network.

Communication between the control module and the physical management module takes place using the Ethernet protocol. This is because the use of this protocol for the exchange of commands and data between these two modules offers flexibility in the implementation of the control module. It is thus possible to imagine a control module implemented in a software fashion on a conventional information system, for example of the PC (Personal Computer) type. This is because any system in a position to communicate over the Ethernet can implement control of the mass memory device. Likewise, because of the use of the Ethernet protocol and its addressing abilities, it is possible to connect a plurality of mass memory devices according to the present disclosure to the same Ethernet network. These devices can be managed by the same control module, this control module having to manage the different Ethernet addresses of the different devices in order to send them the commands that are intended for them.

In one embodiment, these commands can also be transported using the UDP protocol (User Datagram Protocol defined by RFC 768) encapsulated in the IP protocol and transported over the Ethernet. This embodiment adds the headers of these respective protocols to the commands transported, which can have a negative effect on the use of the bandwidth of the link between the control module and the memory device, but increases the freedom of implementation. This is because the IP protocol is routable over a complex network composed of interconnected heterogeneous networks such as the internet, which permits increases in the distance between the control module and the mass memory device in an arbitrary manner. It suffices for the control module and the mass memory device to be connected to the same communication network in the IP direction.

FIG. 6 illustrates an example of a communication protocol between the control module and the physical management module of the mass memory. This protocol is based on the sending and reception of data packets. These data packets have a first field at the address 0x0 with a size of two bytes containing an identifier of the protocol used and a version number of this protocol. A second field at the address 0x2 with a size of two bytes contains a sequence number making it possible to detect duplications or losses of packets. A third field at the address 0x4 with a size of two bytes contains a reserved space. A fourth field at the address 0x6 with a size of two bytes contains a command for the physical management module for the physical memory module. A fifth field at the address 0x8 with a size of two bytes contains a memory command, that is to say a command word intended for the memory components in the control to memory direction and a status in the memory to control direction. A sixth field at the address 0x10 with a size of six bytes contains a sector address. A seventh field at the address 0x16 with a size of two bytes contains the size “n” of the data in bytes. An eighth field at the address 0x18 with a size of two bytes contains a reserved space or a checksum able to check the integrity of the header or of the data. A ninth field at the address 0x20 with a variable size of “n” bytes indicated in the seventh field contains any data relating to the command. A tenth field at the address 0x20+n with a size of four bytes contains a checksum for the packet making it possible to detect its integrity. It is obvious that this protocol is only one example and that it is possible to define at this level any protocol for controlling the physical management module for the memory. This protocol must make it possible to transmit read, write and management commands for the physical memory module as defined by the physical management module for this memory. The protocol is bidirectional and makes it possible to send commands to the physical management module as it enables the physical management module to transmit its responses, for example data read.

The packets of this command protocol are transported in Ethernet packets in the data part (the payload) of the packet. The control module therefore implements the high-level functions of management of the mass memory device by decomposing each high-level function into a plurality of physical management commands that are then sent to the physical management module via the sending of Ethernet packets.

As seen above, if it is wished for these packets to be routable to the IP level, it is possible to transport these packets within UDP packets, themselves transported in IP packets. The commands between the control module and the physical management module can then be transmitted by a complex heterogeneous IP network such as the internet.

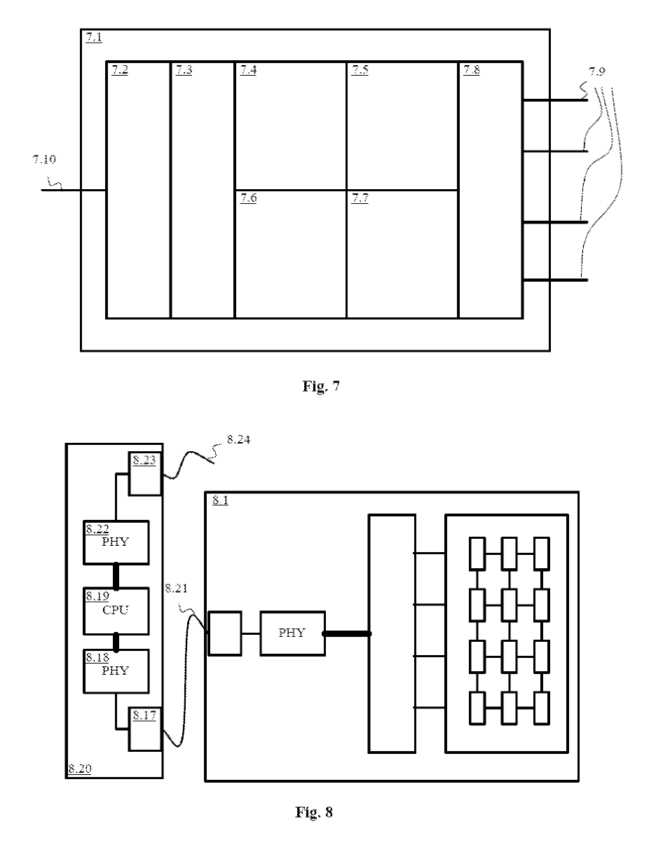

In order to be able to fulfil its role in such an architecture, the physical management module 7.1 for the memory may, for example, have the functional architecture illustrated by FIG. 7. A module 7.2 for adaptation to the MII-family bus 7.10 allows connection of the bus. This module is also responsible for the interpretation and encapsulation of the Ethernet packets and optionally UDP/IP packets. The module 7.3 manages the queues of packets received and to be sent. These queues are of the FIFO (First In First Out) type. The module 7.4 is a module for analysing the commands received. These commands comprise the read, write, delete, initialise, etc. commands. The module 7.5 is the module for executing the commands. It controls the memory components of the bank in accordance with commands. The module 7.8 is a module for adaptation to the components actually used in the physical memory module. This is a portability module. If the type of component is changed, it normally suffices to modify this module in order to adapt the physical management module. The links 7.9 are links connecting the physical management module to the components of the bank. The module 7.6 is a module for the verification in streaming mode of the validity of the data written or read in the memories. The errors, correctable or not, are transferred into a state register that can be returned in each packet, the status of FIG. 6. The module 7.5 is a module ensuring the integrity of the data in the memory. It is the module ensuring the atomicity of the writing operations. It manages the cuts and resumptions of supply. For example, during a data block movement, it ensures that the block is correctly written before enabling deletion of the source block.

On the basis of this mass memory device, mass memory devices may be accessible by network or NAS. One example of such an NAS is illustrated in FIG. 8. The NAS is based on a memory device 8.1 of the same type as the one in FIG. 4. Memory Device 8.1 is connected by an Ethernet link 8.21 to a host 8.20 that provides control thereof. Host 8.20 contains the Ethernet socket 8.17 allowing connection to device 8.1. Socket 8.17 is managed by an Ethernet physical management module 8.18. Control is effected by the processor 8.19 connected to Ethernet physical management module 8.18 by a bus in the MII-family. Processor 8.19 therefore takes responsibility for controlling mass memory device 8.1. Processor 8.19 of host 8.20 is also connected by another MII-family bus to another Ethernet physical management module 8.22 managing a new Ethernet socket 8.23. Socket 8.23 makes it possible to connect the host to a communication network by a link 8.24. Simply by carrying on the processor 8.19 a stack of network protocols and the protocols for exposing the memory device on the network, in this way an NAS functionally equivalent to traditional NASs is obtained. However, this architecture is simpler because it comprises only one processor, processor 8.19 of host 8.20. The principal processor of the NAS also fulfils the control function without requiring a processor dedicated to this control within the mass memory. Therefore, a NAS is obtained the price of which is lower than that of a conventional NAS. Moreover, the certification of the NAS from the point of view of security is facilitated thereby.

It is therefore found that the architecture of a mass memory device based on the use of an MII-family bus as a communication link with the physical management module for the memory enables a set of simple effective devices to be designed. It thus becomes easy to offset these devices at long distances from their control module. It is also easy to develop the capacity by adding such devices under the control of the same controller on an Ethernet network, or even an IP network in certain embodiments. It is possible for example to use such devices for distributing memories recording the flight parameters at various points on an aircraft, increasing accordingly the chances of recovering this information following an accident. Because of the simplicity of design of the mass memory device, the certification thereof from the point of view of security is facilitated.

1-8. (canceled)

9. A mass memory device, including:
a memory module;
a management module for physical management of the memory module; and
a control module for controlling the management module;
wherein the management module is connected for communication with the control module by an MII-family bus.

10. The device according to claim 9, wherein the memory module includes a plurality of flash memory components.

11. The device according to claim 9, wherein the management module manages reading data from and writing data to the memory module.

12. The device according to claim 9, wherein the management module includes a programmable component.

13. The device according to claim 12, wherein the MII-family bus is connected to the programmable component.

14. The device according to claim 9, wherein the control module includes a processor and an MAC Ethernet module connected to the MII-family bus.

15. The device according to claim 9, wherein the MII-family bus is a GMII version bus.

16. The device according to claim 9, wherein the control module is integrated in the device and directly connected to the management module via the MII-family bus.

17. The device according to claim 16, further including a link adaptation module controlled by the control module and configured to manage a communication interface for communication with a host system.

18. The device according to claim 9, further including:
an Ethernet socket; and
an Ethernet management module directly connected to the MII-family bus and configured to manage the Ethernet socket.

19. A storage system, including:
a host system having
a host Ethernet socket,
a host Ethernet management module for managing the host Ethernet socket, and
a control module including a processor;
at least one mass memory device having
a memory module,
a device management module for physical management of the memory module,
a device Ethernet socket,
a device Ethernet management module configured to manage the device Ethernet socket, and
a device MII-family bus connected between the device management module and the device Ethernet management module; and
an Ethernet link connecting the device Ethernet socket to the host Ethernet socket;
wherein the control module is connected to the host Ethernet management module via a host MII-family bus, thereby enabling the control module to control the device management module through the Ethernet link.

20. The storage system according to claim 19, wherein the control module is implemented in software for execution by a personal computer.

21. The device according to claim 19, wherein the device management module manages reading data from and writing data to the memory module.

22. The device according to claim 19, wherein the device MII-family bus is connected to a programmable component of the device management module.

23. The device according to claim 19, wherein the control module includes an MAC Ethernet module connected to the host MII-family bus.

24. The storage system according to claim 19, wherein the control module and the device management module include means for managing a command protocol for passing data packets over the Ethernet link in accordance with an Ethernet standard.

25. The storage system according to claim 24, wherein the control module and the device management module further include means for managing the command protocol in UDP data packets encapsulated in IP data packets transported in Ethernet packets to pass commands of the command protocol over an IP network connected to the host system.

26. The storage system according to claim 19, wherein the host system further includes:
at least a second Ethernet socket configured to connect the host system to a communication network; and
means for managing a complete stack of network protocols by the control module for the host system to expose the at least one mass memory device on the communication network, thereby forming a mass memory device accessible via the communication network.

27. A method of remotely communicating with a mass memory device, including the steps of:
providing a host system having
a host Ethernet socket,
a host Ethernet management module for managing the host Ethernet socket, and
a control module including a processor;
providing at least one mass memory device having
a memory module,
a device management module for physical management of the memory module,
a device Ethernet socket,
a device Ethernet management module configured to manage the device Ethernet socket, and
a device MII-family bus connected between the device management module and the device Ethernet management module; and
connecting the device Ethernet socket to the host Ethernet socket using an Ethernet link;
connecting the control module to the host Ethernet management module using a host MII-family bus; and
using the control module to communicate with the device management module through the Ethernet link.
